(19) United States
(12) Patent Application Publication
(10) Pub. No.: US 2018/0245512 A1
(43) Pub. Date: Aug. 30, 2018

(54) Twin spool industrial gas turbine engine low pressure compressor with diffuser

(71) Applicant: Florida Turbine Technologies, Inc., Jupiter, FL (US)

(72) Inventors: Joseph D. Brostmeyer, Jupiter, FL (US); Russell B. Jones, North Palm Beach, FL (US); John A. Orosa, Jupiter, FL (US)

(21) Appl. No.: 15/444,374

(22) Filed: Feb. 28, 2017

(51) Int. Cl. F02C 6/08; F02C 7/18; F02C 3/04; F04D 19/02; F04D 29/54

(52) U.S. Cl. CPC F02C 6/08; F02C 7/18; F02C 3/04; F05D 2260/232; F04D 29/545; F05D 2220/32; F05D 2220/76; F04D 19/02

(57) ABSTRACT

An industrial gas turbine engine with a high spool and a low spool in which low pressure compressed air is supplied to the high pressure compressor, and where a portion of the low pressure compressed air is bled off for use as cooling air for hot parts in the high pressure turbine of the engine. Annular bleed off channels are located in the LPC diffuser. The bleed channels bleed off around 15% of the core flow and pass the bleed off air into a cooling flow channel that then flows into the cooling circuits in the turbine hot parts.

### GOVERNMENT LICENSE RIGHTS

This invention was made with Government support under contract number DE-FE0023975 awarded by Department of Energy. The Government has certain rights in the invention.

Twin spool industrial gas turbine engine low pressure compressor with diffuser.

### CROSS-REFERENCE TO RELATED APPLICATIONS

None.

### BACKGROUND OF THE INVENTION

### Field of the Invention

The present invention relates generally to an industrial gas turbine engine for electric power generation, and more specifically, to cooling air bleed off from a low pressure compressor (LPC) diffuser to improve the diffuser performance.

### Description of the Related Art Including Information Disclosed Under 37 CFR 1.97 and 1.98

An industrial gas turbine engine is used for electrical power production where the engine drives an electric generator. Compressed air from a compressor is burned with a fuel in a combustor to produce a hot gas stream that is passed through a turbine, where the turbine drives the compressor and the electric generator through the rotor shaft. In an industrial gas turbine for electric power production, the speed of the generator is the same as the rotor of the engine since the use of a speed reduction gear box decreases the efficiency of the engine. For a 60 Hertz system, the generator and engine speed is 3,600 rpm. For a 50 Hertz system like that used in Europe, the generator and the engine speed is 3,000 rpm.

Engine efficiency can be increased by passing a higher temperature hot gas stream through the turbine. However, the turbine inlet temperature is limited to material properties of the turbine parts exposed to the hot gas stream such as rotor blades and stator vanes especially in the first stage. For this reason, first stage airfoils are cooled using cooling air bled off from the compressor. Cooling air for the airfoils passes through elaborate cooling circuits within the airfoils, and is typically discharged out film cooling holes on surfaces where the highest gas stream temperature are found. This reduces the efficiency of the engine since the work done by the compressor on compressing the cooling air is lost when the spent cooling air is discharged directly into the turbine hot gas stream because no additional work is done on the turbine.

### BRIEF SUMMARY OF THE INVENTION

An industrial gas turbine engine for electrical power production, where the engine includes a high spool that drives an electric generator and a separate low spool that produces compressed air that is delivered to an inlet of the high pressure compressor (HPC) for turbocharging the high spool. A portion of the low pressure compressor (LPC) outflow or core flow is bled off and used as the cooling air for hot parts of the high pressure turbine (HPT). The cooling air flows through the hot parts for cooling, and is then discharged into the combustor and burned with fuel to produce the hot gas stream for the turbine. The work done on the compressed cooling air is thus not lost but used to produce work in the turbine.

In another embodiment of the present invention, some of the core flow from the diffuser is drawn off using a fan driven by the rotor of the engine to improve the performance of the diffuser. The drawn off core flow is then merged back into the core flow.

In another embodiment of the present invention similar to the second embodiment above, the fan is driven by a motor external to the main duct and the engine.

### BRIEF DESCRIPTION OF THE SEVERAL VIEWS OF THE DRAWINGS

FIG. 1 shows a cross sectional view of a twin spool industrial gas turbine engine with a closed loop turbine airfoil cooling circuit of the present invention.

FIG. 2 shows a low pressure compressor of an industrial gas turbine engine with a diffuser having some of the core flow drawn off and used as cooling air for hot parts of the turbine according to the present invention.

FIG. 3 shows a cross sectional view of a low pressure compressor of an industrial gas turbine engine with a diffuser in which some of the core flow is drawn off from the diffuser by a fan driven by the engine rotor to improve the diffuser performance of the present invention.

FIG. 4 shows a cross sectional view of a low pressure compressor of an industrial gas turbine engine with a diffuser in which some of the core flow is drawn off from the diffuser by a fan driven by a motor external to the engine to improve the diffuser performance of the present invention.

### DETAILED DESCRIPTION OF THE INVENTION

The present invention is a twin spool industrial gas turbine (IGT) engine for electrical power production with a low spool having a low pressure compressor and a diffuser, where some of the core flow from the compressor discharged is drawn off and used as cooling air for turbine hot parts, or where some of the core flow is drawn off by a fan in order to improve the performance of the diffuser. The cooling air is passed through turbine hot parts (such as stator vanes, rotor blades, rotor disks, combustor liners) to be cooled, and then reintroduced into the compressed air from the high pressure compressor upstream of the combustor. The cooling air bled off from the LPC passes through a boost compressor to increase its pressure prior to passing through the hot parts to be cooled so that enough pressure remains after cooling of the hot parts to be discharged into the combustor along with compressed air from the main compressor. The core flow drawn off by the fan to improve the diffuser performance is reintroduced into the core flow duct upstream of the inlet to the high pressure compressor. Cooling air for the turbine hot parts can then be extracted from the core flow duct between the merge section and the inlet to the high pressure compressor.

The outlet of the low pressure compressor (LPC) includes a diffuser with bleed off channels that bleed off a portion of the core flow from the LPC using a fan to draw off the compressed air through the bleed off channels that functions to increase the efficiency of the diffuser. The bleed off compressed air is then reintroduced into the core flow that flows to an inlet of a high pressure compressor (HPC) where some of the core flow is bled off and used for cooling of the high pressure turbine (HPT) hot parts such as stator vanes or rotor blades.

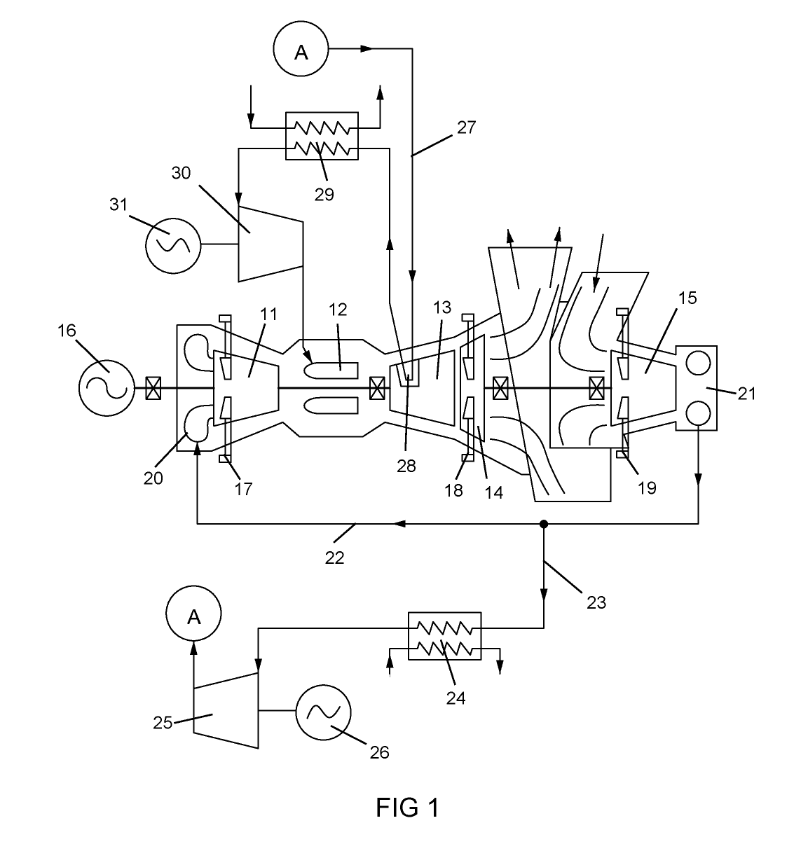

FIG. 1 shows a twin spool industrial gas turbine engine of the present invention for electrical power production. The IGT engine includes a high spool with a HPC 11, a combustor 12 and a HPT 13 that directly drives an electric generator 16. The IGT engine also includes a low spool which functions as a turbocharger for the high spool and includes a LPT 14 that drives a LPC 15 using the exhaust gas from the HPT 13. The LPC 15 compresses air and discharges the compressed air out a manifold 21 and into a main flow or core flow duct 22 that delivers low pressure air to an inlet manifold 20 of the HPC 11 of the high spool. The HPC 11 and the LPC 15 and the HPT 13 each includes a variable inlet guide vane assembly (17, 19, 18) that regulates flow into each of these parts of the engine.

The core flow from the LPC 15 to the HPC 11 through the core flow duct 22 has a cooling air line 23 that removes some of the core flow to be used as cooling air for a hot part of the HPT 13 such as a first stage stator vanes or rotor blades in a closed loop circuit in which the spent cooling air is then discharged into the combustor 12 of the high spool. The cooling air must be increased in pressure to pass through the cooling circuit of the turbine parts and still have enough pressure to flow into the combustor 12. An intercooler 24 cools the compressed air and a boost compressor 25 driven by a motor 26 increases the pressure of the cooling air. a second intercooler 29 and a second boost compressor 30 driven by a second motor 31 can be used to increase the pressure of the spent cooling air prior to discharge into the combustor 12.

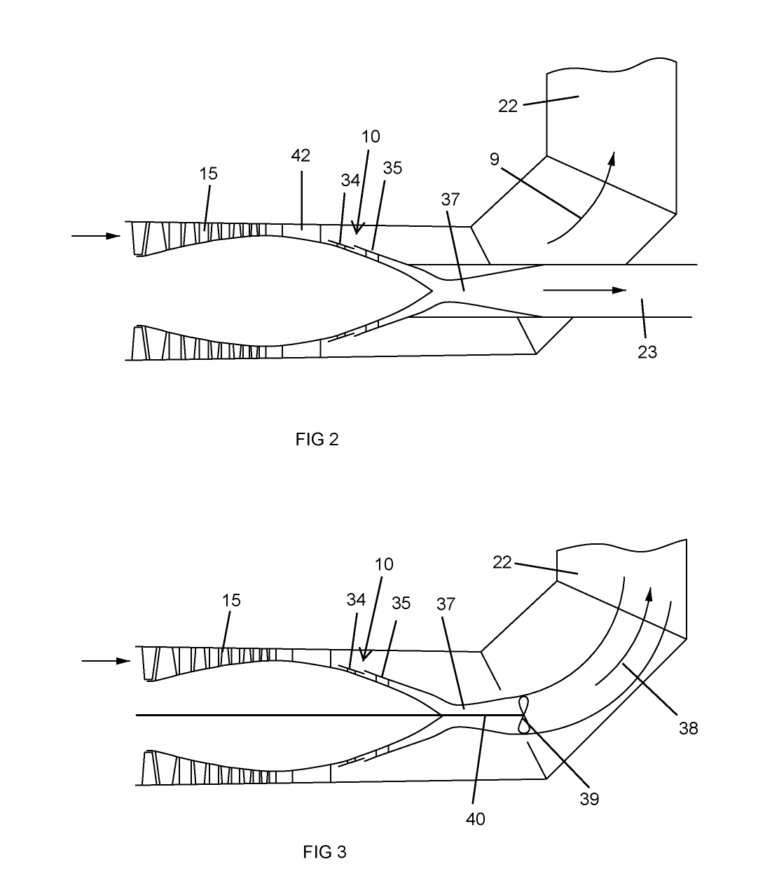

FIG. 2 shows the low pressure compressor (LPC) 15 of the IGT engine with multiple rows or stages of rotor blades and stator vanes followed by a LPC diffuser 10 and a cooling flow diffuser 37. Compressed air from the compressor exit flows along an inner surface where first and second bleeds 34 and 35 are located that bleeds off compressed air from the core flow 9. A strut 42 is located aft of the LPC 15 and near the inlet of the LPC diffuser 10. In this embodiment of the present invention, the two bleeds 34 and 35 each remove around 7.5% of the core flow for a total bleed off of 15% that then flows into a cooling air duct 23. The core flow 9 flows through a main flow duct 22 and into the inlet of the high pressure compressor (HPC) of the engine. The cooling air passing into the cooling air duct 23 flows to hot parts of the engine such as the first stage stator vanes and even the first stage rotor blades to provide cooling for these hot turbine parts.

The cooling flow 34 and 35 enable a higher diffusion rate in the LPC diffuser 10 by restarting the boundary layer on the LPC diffuser 10 inner diameter (ID) flow path. The LPC diffuser 10 OD flow path loading is mitigated with zero slope flow path and OD strong LPC exit velocity profile. Cooling air duct 23 diffusion in the cooling flow diffuser 37 can be delayed to minimize blockage by the cooling air duct 23 inside the LPC-to-HPC duct. The bleed off compressed air from the bleeds 34 and 35 flows into a throat and then through a cooling flow diffuser 37 before entering the cooling air duct 23.

FIG. 3 shows an embodiment of the present invention in which the compressed air bled off through the bleeds 34 and 35 is reintroduced into the core flow duct 22 downstream where a fan 39 is used to draw off the bleed air through the bleed passages 34 and 35 to improve the diffuser 10. In the FIG. 3 embodiment, the fan 39 is connected to the rotor 40 of the LPC 15. The fan 39 draws off the bleed air into a passage 38 that is then merged with the core flow of the duct 22 from the LPC 15. The fan 39 improves the performance of the LPC diffuser 10. In the FIG. 3 embodiment, the air drawn off from the diffuser is driven by a fan connected to the rotor of the low spool. In the FIG. 3 embodiment, the cooling air used for cooling of the turbine hot parts can be extracted from the core flow duct 22 downstream from the where fan draws off the diffuser flow and upstream of where the core flow is discharged into the inlet of the high pressure compressor.

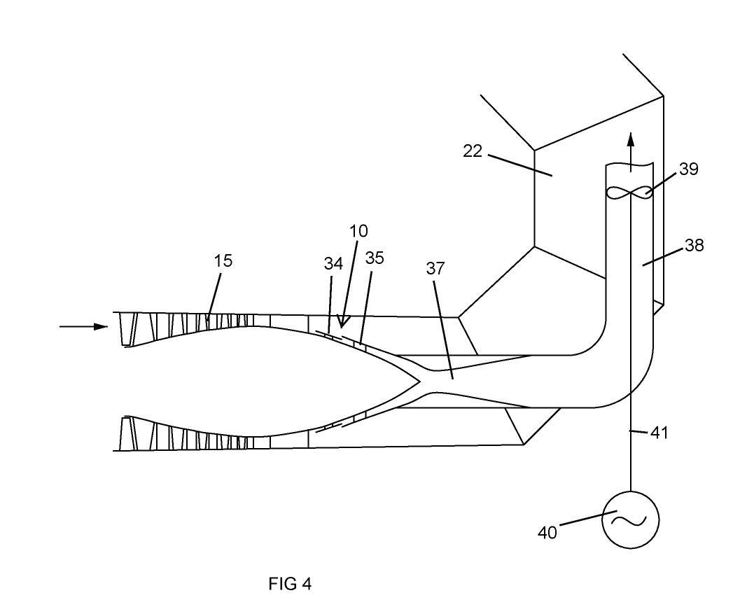

FIG. 4 shows a second embodiment of the present invention in which the compressed air bled off through the bleeds 34 and 35 is drawn off by a fan 39 driven by an external motor 40 through a shaft 41. The compressed air bleed off through the diffuser 10 is then reintroduced into the core flow in the duct 22 downstream from the diffuser 10 to improve the performance of the diffuser 10. In the FIG. 4 embodiment, the fan that draws off the flow from the diffuser is driven by a motor 40 external to the low spool and the IGT engine.

In both embodiments of FIGS. 3 and 4, some of the air flow discharged from the low pressure compressor is drawn off from the diffuser using a fan in order to improve the diffuser performance, and where this drawn off air is reintroduced into the core flow duct downstream but upstream of where cooling air for the turbine hot parts is extracted from the core flow duct.

We claim the following:

1: An industrial gas turbine engine for electrical power production comprising:
a high spool with a high pressure compressor and a high pressure turbine;
a low spool with a low pressure compressor (LPC) and a low pressure turbine;
a compressed air duct connecting a core flow of the LPC to an inlet of the high pressure compressor;
a LPC diffuser air bleed channel to bleed off a portion of the core flow; and,
a cooling flow channel connected to the LPC diffuser air bleed channel.

2: The industrial gas turbine engine of claim 1, and further comprising:
the LPC diffuser air bleed channel bleeds off around 7.5% of the core flow of the LPC diffuser.

3: The industrial gas turbine engine of claim 1, and further comprising:
a second LPC diffuser air bleed channel located downstream from the first LPC diffuser air bleed channel to bleed off a second portion of the core flow; and,
the second LPC diffuser air bleed channel is connected to the cooling flow channel.

4: The industrial gas turbine engine of claim 3, and further comprising:
the first and second LPC diffuser air bleed channels bleed off around 15% of the core flow of the LPC diffuser.

5: The industrial gas turbine engine of claim 1, and further comprising:
the LPC diffuser air bleed channel is an annular shaped channel.

6: The industrial gas turbine engine of claim 3, and further comprising:
the first and second LPC diffuser air bleed channels are both annular in shape; and,
compressed air from the first bleed channel flows into the second bleed channel.

7: The industrial gas turbine engine of claim 1, and further comprising:
the LPC diffuser air bleed channel is an annular shaped channel on an inner surface of the LPC diffuser that forms the core flow of the LPC.

8: The industrial gas turbine engine of claim 1, and further comprising:
the LPC diffuser air bleed channel is an annular shaped channel; and,
a throat followed by a diverging section is located between the annular bleed channel and the cooling flow channel.

9: The industrial gas turbine engine of claim 3, and further comprising:
a third LPC diffuser air bleed channel located on an outer surface of the LPC diffuser to bleed off a third portion of the core flow; and,
the third low pressure compressed air bleed channel is connected to the cooling flow channel.
